(19) United States
(12) Patent Application Publication
(10) Pub. No.: US 2026/0112114 A1
(43) Pub. Date: Apr. 23, 2026

(54) PRIMITIVE PROCESSING METHOD IN RASTERIZER STAGE, GRAPHIC PROCESS UNIT, COMPUTER-READABLE STORAGE MEDIUM, AND PROGRAM PRODUCT

(71) Applicant: Glenfly Tech Co., Ltd., Shanghai (CN)

(72) Inventors: Wenlin HAO, Shanghai (CN); Fengxia WU, Shanghai (CN)

(21) Appl. No.: 19/219,351

(22) Filed: May 27, 2025

(30) Foreign Application Priority Data
Oct. 17, 2024 (CN) 202411457552.5

(51) Int. Cl. G06T 17/10; G06T 7/13; G06T 15/00; G06T 19/20

(52) U.S. Cl. CPC G06T 17/10; G06T 7/13; G06T 15/005; G06T 19/20; G06T 2210/12; G06T 2219/2004

(57) ABSTRACT

The present disclosure describes a primitive processing method for a rasterizer stage, a graphic process unit, a computer-readable storage medium, and a computer program product. The method includes: acquiring a primitive and vertex information of the primitive; determining a type of the primitive according to the vertex information; removing the primitive when the type of the primitive is a to-be-removed primitive; and when the type of the primitive is a non-to-be-removed primitive, determining a pixel attribute of the primitive according to the vertex information of the primitive, wherein the pixel attribute is configured to be inputted into a pixel shader. The method can reduce the computational pressure of the graphic process unit during the rasterizer stage, and improve the performance of the GPU.

### CROSS-REFERENCE TO RELATED APPLICATION

This application claims priority to Chinese Patent Application No. 202411457552.5, filed with the China National Intellectual Property Administration on Oct. 17, 2024 and entitled “Primitive Processing Method in Rasterizer Stage, Graphic Process Unit, Computer-Readable Storage Medium, and Computer Program Product”, which is incorporated herein by reference in its entirety.

### TECHNICAL FIELD

The present disclosure relates to the field of image data processing technology, particularly to a primitive processing method for a rasterizer stage, a graphic process unit, a computer-readable storage medium, and a computer program product.

### BACKGROUND

The most significant new feature of 3D graphics is tessellation, which utilizes the hardware acceleration of the Graphic Process Unit (GPU) to split the primitives that constitute the 3D model into smaller and finer pieces, thereby achieving the effect of making the surfaces of rendered objects smoother and the edges more refined. At the same time, the problem brought about is that the number of primitives increases significantly, which may multiply the pressure on the rasterizer stage of the GPU pipeline, that is, a primitive setup unit may have to bear a huge workload due to the multiplication of the number of primitives.

### SUMMARY

In view of this, in order to address the above technical problem, it is necessary to provide a primitive processing method for a rasterizer stage, a graphic process unit, a computer-readable storage medium and a computer program product capable of reducing the computational pressure in the rasterizer stage.

In the first aspect of the present disclosure, a primitive processing method for a rasterizer stage is provided, including: acquiring a primitive and vertex information of the primitive; determining a type of the primitive according to the vertex information; removing the primitive when the type of the primitive is a to-be-removed primitive; and determining a pixel attribute of the primitive according to the vertex information of the primitive when the type of the primitive is a non-to-be-removed primitive. The pixel attribute is configured to be inputted into a pixel shader.

In an embodiment, the vertex information includes vertex position information, determining the type of the primitive according to the vertex information includes: determining an edge function and bounding box information of the primitive according to the vertex position information; and determining the type of the primitive according to the edge function and the bounding box information of the primitive.

In an embodiment, determining the edge function and the bounding box information of the primitive according to the vertex position information includes: determining the edge function of the primitive according to vertex position information and an initial edge function for each vertex of the primitive; and determining the bounding box information of the primitive according to an extreme value of the vertex position information of each vertex of the primitive.

In an embodiment, determining the type of the primitive according to the edge function and the bounding box information of the primitive includes: when the bounding box information satisfies a preset condition of the bounding box, determining the primitive as the non-to-be-removed primitive; when the bounding box information dissatisfies the preset condition of the bounding box, determining a size type of the primitive according to the bounding box information; and determining the type of the primitive according to the bounding box information, the vertex position information, and the edge function for the size type.

In an embodiment, the bounding box information comprises a bounding box size and a bounding box coordinate, determining the type of the primitive according to the bounding box information, the vertex position information, and the edge function includes: determining a first determination parameter according to the bounding box coordinate, the vertex position information, and the edge function; determining a target quantity of sets of second determination parameters according to the first determination parameter, the bounding box size, and the edge function, wherein the target quantity of sets is determined according to the bounding box size; and determining the primitive as the to-be-removed primitive when at least one second sub-determination parameter in each set of second determination parameters is less than or equal to 0.

In an embodiment, determining the first determination parameter according to the bounding box coordinate, the vertex position information, and the edge function includes: inputting the bounding box coordinate, the vertex position information, and the edge function into a first expression to obtain the first determination parameter; determining a second determination parameter according to the first determination parameter, the bounding box size, and the edge function includes: inputting the first determination parameter, the bounding box size, and the edge function into a second expression to obtain the second determination parameter; the bounding box coordinate includes a first bounding box coordinate; a generation mode of the first expression comprises: substituting vertex position information of each vertex of the primitive into a target edge function corresponding to each vertex, and obtaining a first function; substituting the first bounding box coordinate of the primitive into the target edge function, and obtaining a second function; determining the first expression according to the first function and the second function; the bounding box coordinate includes a second bounding box coordinate; the first bounding box coordinate and the second bounding box coordinate are determined according to a first coordinate element and a second coordinate element; a generation mode of the second expression includes: substituting the second bounding box coordinate of the primitive into the target edge function, and obtaining a third function; and determining the second expression according to the third function, the first function, and the first expression.

In the second aspect of the present disclosure, a graphic process unit (GPU) is provided, which includes a memory storing a computer program, a geometry shader (GS), a rasterizer unit (RSU), and a pixel shader (PS). The GS is configured to process an image to output a primitive and corresponding vertex information; the RSU, when executing the computer program, implements the steps of the method of any one of the above-mentioned embodiments; the PS is configured to acquire a pixel attribute and perform shading processing according to the pixel attribute.

In an embodiment, the RSU includes a primitive setup unit (PSU), a computational logic unit of the PSU is provided with a first signal input port, a second signal input port, a third signal input port, and a signal output port; the first signal input port is configured to receive a first coordinate element signal, the second signal input port is configured to receive a second coordinate element signal, the third signal input port is configured to receive a size type signal of the primitive, the signal output port is configured to output a sign signal indicating whether to remove the primitive.

In the third aspect of the present disclosure, a non-transitory computer-readable storage medium is provided, on which a computer program is stored. The computer program, when executed by a rasterizer unit, causes the rasterizer unit to implement the method of any one of the above-mentioned embodiments.

In the fourth aspect of the present disclosure, a computer program product is provided, including a computer program. The computer program, when executed by a rasterizer unit, causes the rasterizer unit to implement the method of any one of the above-mentioned embodiments.

With the above primitive processing method for the rasterizer stage, the graphic process unit, the computer-readable storage medium and the computer program product, the primitive and the vertex information of the primitive are acquired, the type of the primitive is determined according to the vertex information of the primitive, and different processing operations are performed according to different types of primitives. When the type of the primitive is the to-be-removed primitive, the primitive is removed. When the type of the primitive is the non-to-be-removed primitive, the pixel attribute of the primitive is determined according to the vertex information of the primitive, and the pixel attribute is configured to be inputted into the pixel shader. Before the pixel attribute of the primitive is calculated, a primitive that do not need to be drawn is removed in advance, which greatly reduces the number of primitives needing to be processed subsequently, thereby reducing the resource occupation of the GPU in the rasterizer stage and improving the performance of the GPU.

### BRIEF DESCRIPTION OF THE DRAWINGS

In order to describe the technical solution in the embodiments of the present disclosure or the related technologies more clearly, the accompanying drawings required for describing the embodiments of the present disclosure or the related technologies are briefly introduced. Obviously, the accompanying drawings in the following description show merely some embodiments of the present disclosure, and those skilled in the art may still obtain other related drawings according to these accompanying drawings without any creative efforts.

FIG. 1 is a schematic diagram of a high-detail model and other models according to an embodiment.

FIG. 2 is a schematic diagram illustrating a to-be-removed triangle and a retained triangle according to an embodiment.

FIG. 3 is a schematic diagram illustrating a conventional GPU architecture according to an embodiment.

FIG. 4 is a flow chart showing a primitive processing method for a rasterizer stage according to an embodiment.

FIG. 5 is a flow chart of determining a type of a primitive according to an embodiment.

FIG. 6 is a flow chart of determining an edge equation and bounding box information according to an embodiment.

FIG. 7 is a schematic diagram of a bounding box of a primitive according to an embodiment.

FIG. 8 is a flow chart of determining a type of a primitive according to another embodiment.

FIG. 9 is a flow chart of determining a type of a primitive according to another embodiment.

FIG. 10 is a flow chart of determining a type of a primitive according to another embodiment.

FIG. 11 is a flow chart of obtaining a first determination parameter and a second determination parameter according to an embodiment.

FIG. 12 is a flow chart of determining a first expression and a second expression according to an embodiment.

FIG. 13 is a schematic diagram illustrating a to-be-removed triangle and a retained triangle according to another embodiment.

FIG. 14 is a schematic diagram of a GPU architecture after a primitive setup unit is improved according to an embodiment.

FIG. 15 is a schematic architecture diagram of a computational logic unit of a primitive setup unit according to an embodiment.

### DETAILED DESCRIPTION OF THE EMBODIMENTS

In order to make the purpose, technical solution and advantages of the present disclosure more clearly understood, the present disclosure is further described in detail below in conjunction with the accompanying drawings and embodiments. It should be appreciated that the specific embodiments described herein are merely used for illustrating the present disclosure, rather than limiting the present disclosure.

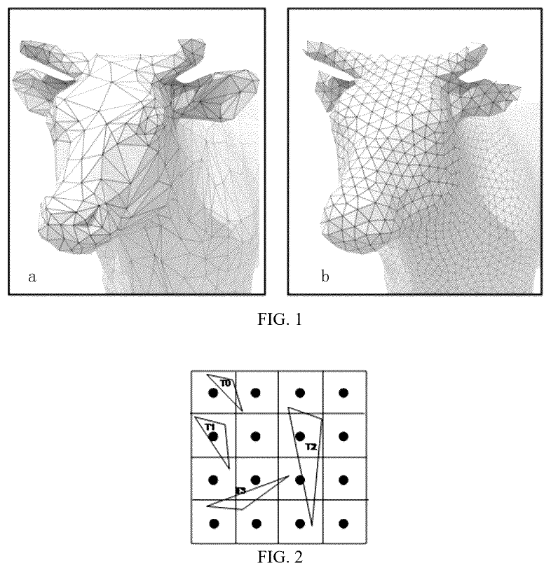

The most significant new characteristic of Direct3D 11 is tessellation, which utilizes GPU hardware acceleration to split primitives that constitute a 3D model into smaller and finer pieces, thereby achieving the effect of making a surface of a rendered object smoother and an edge more refined. To illustrate with an example of triangle primitives, as shown in FIG. 1, FIG. 1(a) is a conventional 3D graphic, and FIG. 1(b) is a Direct3D 11 graphic. The number of triangles in FIG. 1(b) is far greater than that in FIG. 1(a). When the 3D graphic in FIG. 1(b) is processed, a pressure on a rasterizer stage of a GPU pipeline may be multiplied, that is, a triangle setup unit may handle a much larger workload due to the multiplication of the number of triangles. Data provided in “3D Graphics Programming Foundation-Based on Direct3D 11” is taken as an example.

TABLE 1
comparison of parameters of high-detail model with other models

| | Use tessellation | | | |
|---|---|---|---|---|
| | technology and | | | |
| | low-detail model | | High-detail model | |
| Original model | 840 | triangles | 1,280,038 | triangles |
| Rendering size | 1,008,038 | triangles | 1,280,038 | triangles |
| Vertex data occupancy | 70 | KB | 31 | MB |
| Time consumption | 1.22 | ms | 2.82 | ms |

From the above table, it can be seen that when the high-detail model is used, the number of triangles is very large, which may cause the 3D pipeline to be overloaded. After analysis and statistics, the large number of triangles generated by the tessellation are small triangles. High-detail models mostly use small triangles in order to achieve a more ideal drawing effect. These small triangles sometimes do not cover pixel sampling points, and finally do not need to be drawn, as shown in FIG. 2. FIG. 2 is an image block of 4*4 pixels, each point represents a pixel center. T0 and T3 do not cover the pixel sampling points and finally do not need to be drawn. According to the analysis and prediction of GPU performance, in the Direct3D 11 Benchmark test, approximately 2.39% to 13.75% of the small triangles finally do not need to be drawn. The pixel sampling points are determined according to coordinates of the bounding box.

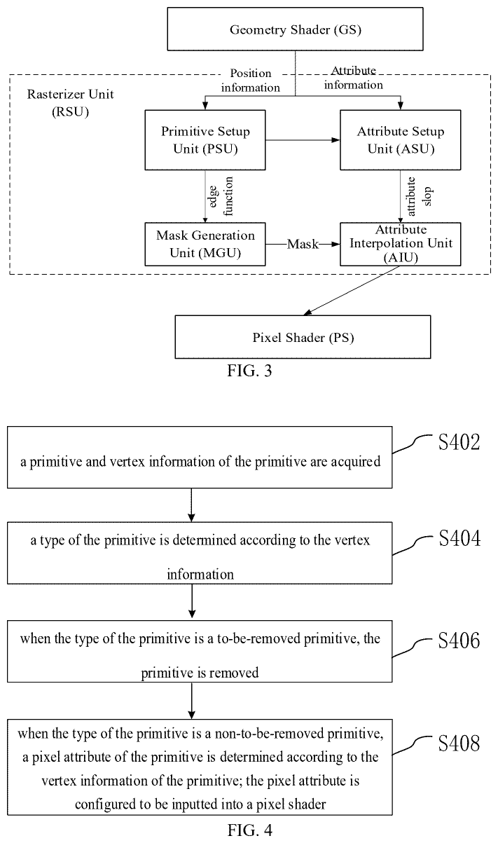

The small triangles that finally do not need to be drawn may be designed according to the conventional GPU architecture, as shown in FIG. 3. Vertex information of a primitive outputted by a Geometry Shader (GS) may include vertex position information and vertex attribute information. A rasterizer unit (RSU) may receive the vertex information of the primitive. The rasterizer unit may include a primitive setup unit (PSU) which specifically may be a triangle setup unit (TSU). The rasterizer unit may further include an attribute setup unit (ASU), a mask generation unit (MGU), and an attribute interpolation unit (AIU). Their functions are as follows.

Primitive Setup Unit (PSU): a triangle setup unit (TSU), which calculates an edge function of a primitive according to vertex position information.

Attribute Setup Unit (ASU): the ASU calculates slops of an attribute value along x-axis and y-axis according to the vertex attribute information and vertex position information.

Mask Generation Unit (MGU): the MGU calculates a screen pixel covered by a primitive according to the edge function and generates a corresponding pixel mask.

Attribute Interpolation Unit (AIU): the AIU interpolates an attribute value of each pixel according to the mask and the attribute slop, and transmits the attribute value to the pixel shader (PS).

According to the above process, until the work of the MGU is completed, a current triangle may be discarded when a pixel mask generated by the current triangle is 0. This means that these small triangles that do not need to be drawn still occupy a calculation resource of the MGU, as well as calculation resources of the TSU and ASU before the MGU, which need to perform complex calculations of the edge function and the attribute slop.

When facing such a huge data calculation of small triangles, the load on the 3D pipeline is likely to be unbalanced. The resources of the TSU and the ASU may be limited, since the edge function and the attribute slop need to be calculated for each triangle, ultimately only a few pixels of data may be generated, and even a triangle is discarded due to a too small size. In other words, the pressure at the front end of the pipeline (the rasterizer, the TSU, the ASU, and the MGU) is significantly greater than that at the back end of the pipeline (the AIU, the PS and the subsequent modules).

According to the analysis and prediction of the GPU performance, in the testing on benchmark test software of Direct3D 11, approximately 2.39% to 13.75% of small triangles finally do not need to be drawn. If these small triangles that do not need to be drawn can be removed from the GPU pipeline as early as possible, a calculation pressure in the rasterizer stage can be greatly reduced and the overall performance of the GPU can be improved.

In the embodiment of the present disclosure, the primitive processing method in the rasterizer stage is provided, which can be applied to the GPU which includes the GS, the RSU, and the PS, and can also be applied to the RSU in the GPU.

In an exemplary embodiment, as shown in FIG. 4, a primitive processing method for a rasterizer stage is provided, and the method is applied to the GPU for an example to illustrate. The method may include the following steps S402 to S408.

Step S402: a primitive and vertex information of the primitive are acquired.

An output primitive of a geometric element of a described object is referred to as a geometric primitive, or a primitive for short, such as a point, a straight line segment, a circle, a quadratic curve, a curved surface, a triangle, a polygon, etc. A primitive (such as a line segment, a triangle, a circle, or other geometric figures) consists of a vertex and an edge. The vertex information may include vertex position information and vertex attribute information.

Optionally, the primitive and the vertex information of the primitive are output by the GPU through the GS. The vertex information of the primitive includes vertex position information and vertex attribute information. The GPU receives, through the RSU, the primitive and the vertex information of the primitive outputted by the GS. For example, the GPU receives, through the RSU, the triangle and the triangle vertex information outputted by the GS. In another example, the GPU receives, through the RSU, the polygon and the polygon vertex information outputted by the GS.

Step S404, a type of the primitive is determined according to the vertex information.

The type of the primitive may include a to-be-removed primitive and a non-to-be-removed primitive.

Optionally, the GPU determines the type of the primitive through the RSU according to the vertex information, such as the vertex position information. When the GPU receives, through the RSU, the triangle and the triangle vertex information outputted by the GS, the GPU determines the triangle is a to-be-removed triangle through the RSU according to the vertex position information of the triangle. When the GPU receives, through the RSU, the polygon and the polygon vertex information outputted by the GS, the GPU determines the polygon as a to-be-removed polygon through the RSU according to the vertex position information of the polygon.

Step S406: when the type of the primitive is a to-be-removed primitive, the primitive is removed.

Optionally, when the type of the primitive is the to-be-removed primitive, the GPU removes the primitive through the RSU without performing the processing of such as the ASU, the MGU, and the AIU as shown in FIG. 3.

Step S408: when the type of the primitive is a non-to-be-removed primitive, a pixel attribute of the primitive is determined according to the vertex information of the primitive; the pixel attribute is configured to be inputted into a pixel shader.

Optionally, if the type of the primitive is the non-to-be-removed primitive, the GPU calculates the edge function of the primitive through the PSU in the RSU according to the vertex position information. The GPU calculates the attribute slops of the attribute value along the x-axis and y-axis through the ASU in the RSU according to the vertex attribute information and the vertex position information. The GPU calculates a screen pixel covered by the primitive and generates a corresponding pixel mask through the MGU in the RSU according to the edge function. The GPU interpolates an attribute value of each pixel through the AIU in the RSU according to the pixel mask and the attribute slops, and transmits the attribute value into the PS.

It should be noted that the primitive may be a triangle, a polygon, a straight line segment, a quadratic curve, a curved surface, a triangle, a polygon, etc.

In the above primitive processing method for the rasterizer stage, the primitive and the vertex information of the primitive are acquired, the type of the primitive is determined according to the vertex information of the primitive, and different processing operations are performed according to different types of primitives. When the type of the primitive is the to-be-removed primitive, the primitive is removed. When the type of the primitive is the non-to-be-removed primitive, the pixel attribute of the primitive is determined according to the vertex information of the primitive, and the pixel attribute is configured to be inputted into the pixel shader. Before the pixel attribute of the primitive is calculated, a primitive that do not need to be drawn is removed in advance, which greatly reduces the number of primitives needing to be processed subsequently, thereby reducing the resource occupation of the GPU in the rasterizer stage and improving the performance of the GPU.

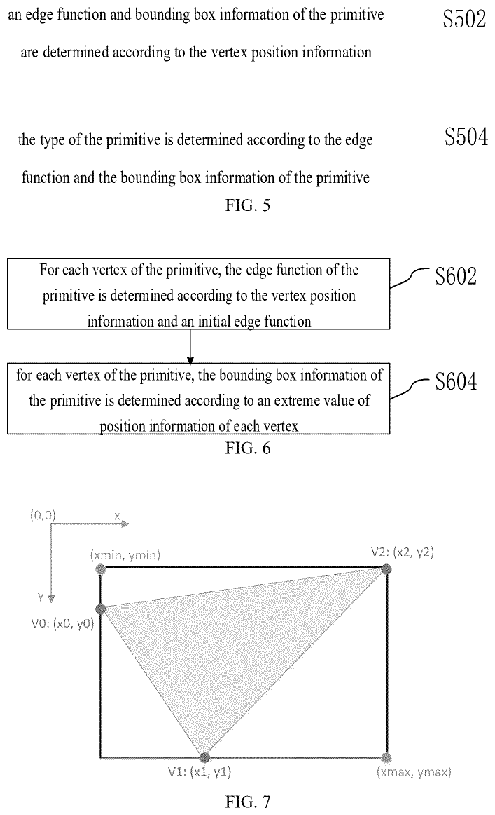

In an exemplary embodiment, as shown in FIG. 5, the vertex information may include vertex position information. The step of determining the type of the primitive according to the vertex information may include steps S502 to S504.

Step S502: an edge function and bounding box information of the primitive are determined according to the vertex position information.

The bounding box is an algorithm for solving an optimal bounding space of a discrete point set, and a basic idea thereof is to use a geometric shape with a slightly larger volume and a simpler characteristic to approximate and replace a complex geometric object.

When the primitive is a triangle, it is supposed that the triangle has three vertices V0, V1, V2, and the corresponding screen coordinates are (x0, y0), (x1, y1), (x2, y2). The PSU can specifically be a triangle setup unit (TSU). The GPU calculates three edge functions V0V1, V1V2, and V2V0 through the TSU in the RSU. The bounding box information is calculated according to the three vertices V0, V1, V2 and the corresponding screen coordinates (x0, y0), (x1, y1), (x2, y2).

When the primitive is a quadrilateral, it is supposed that four vertices thereof are V0, V1, V2, V3 and the corresponding screen coordinates are (x0, y0), (x1, y1), (x2, y2), (x3, y3) respectively. The PSU may be a quadrilateral setup unit. The GPU calculates the four edge functions V0V1, V1V2, V2V3 and V3V0 through the quadrilateral setup unit in the RSU. The bounding box information is calculated according to the four vertices of the quadrilateral and the corresponding screen coordinates.

Step S504: the type of the primitive is determined according to the edge function and the bounding box information of the primitive.

Optionally, the GPU determines the type of the primitive as the to-be-removed primitive or non-to-be-removed primitive through the PSU in the RSU according to the edge function and the bounding box information of the primitive.

It should be noted that the type of the primitive can also be determined according to different primitive vertices and vertex coordinates.

In the embodiment, the type of the primitive is determined in advance according to the edge function and the bounding box information of the primitive. When the type of the primitive is the to-be-removed primitive, the primitive is removed without performing subsequent calculations of the attribute setup, mask generation, and pixel attribute of the primitive, thereby reducing the resource occupation of the GPU in the rasterizer stage and improving the performance of the GPU.

Following the above embodiments, as shown in FIG. 6, the step of determining the edge function and the bounding box information of the primitive according to the vertex position information may include steps S602 to S604.

Step S602: For each vertex of the primitive, the edge function of the primitive is determined according to the vertex position information and an initial edge function.

In the two-dimensional space (e.g., screen space), the initial edge function is expressed in the form of Ax+By+C=0. The vertex position information can be vertex coordinate information.

Optionally, when the primitive is a triangle, it is supposed that the three vertices thereof are V0, V1, V2, and the corresponding screen coordinates are (x0, y0), (x1, y1), (x2, y2) respectively. The PSU can specifically be a triangle setup unit (TSU). The GPU substitutes each vertex coordinate into the initial edge function through the TSU in the RSU, and obtains that:

$$\begin{matrix}the edge function A 0 * X + B 0 * Y + C 0 = 0 of V 0 V 1 : \\ ( {y}_{0} - {y}_{1} ) * x + ( {x}_{1} - {x}_{0} ) * y + ( {x}_{0} * {y}_{1} - {y}_{0} * {x}_{1} ) = 0 ; \\ the edge function A 1 * X + B 1 * Y + C 1 = 0 of V 1 V 2 : \\ ( {y}_{1} - {y}_{2} ) * x + ( {x}_{2} - {x}_{1} ) * y + ( {x}_{1} * {y}_{2} - {y}_{1} * {x}_{2} ) = 0 ; \\ the edge function A 2 * X + B 2 * Y + C 2 = 0 of V 2 V 0 : \\ ( {y}_{2} - {y}_{0} ) * x + ( {x}_{0} - {x}_{2} ) * y + ( {x}_{2} * {y}_{0} - {y}_{2} * {x}_{0} ) = 0.\end{matrix}$$

Optionally, when the primitive is a polygon, such as a quadrilateral, it is supposed that four vertices are V0, V1, V2, V3 and the corresponding screen coordinates are (x0, y0), (x1, y1), (x2, y2), (x3, y3) respectively. The PSU can specifically be a quadrilateral setup unit. The GPU substitutes each vertex coordinate into the initial edge function through the quadrilateral setup unit in the RSU, and obtains that:

$$\begin{matrix}the edge function A 0 * X + B 0 * Y + C 0 = 0 of V 0 V 1 : \\ ( {y}_{0} - {y}_{1} ) * x + ( {x}_{1} - {x}_{0} ) * y + ( {x}_{0} * {y}_{1} - {y}_{0} * {x}_{1} ) = 0 ; \\ the edge function A 1 * X + B 1 * Y + C 1 = 0 of V 1 V 2 : \\ ( {y}_{1} - {y}_{2} ) * x + ( {x}_{2} - {x}_{1} ) * y + ( {x}_{1} * {y}_{2} - {y}_{1} * {x}_{2} ) = 0 ; \\ the edge function A 2 * X + B 2 * Y + C 2 = 0 of V 2 V 3 : \\ ( {y}_{2} - {y}_{3} ) * x + ( {x}_{3} - {x}_{2} ) * y + ( {x}_{2} * {y}_{3} - {y}_{2} * {x}_{3} ) = 0 ; \\ the edge function A 3 * X + B 3 * Y + C 3 = 0 of V 3 V 0 : \\ ( {y}_{3} - {y}_{0} ) * x + ( {x}_{0} - {x}_{3} ) * y + ( {x}_{3} * {y}_{0} - {y}_{3} * {x}_{0} ) = 0.\end{matrix}$$

The triangle is taken as an example for convenience of illustration, a pixel (x, y) is respectively substituted into three edge functions A0*X+B0*Y+C0, A1*X+B1*Y+C1, and A2*X+B2*Y+C2 generated by EDGE_ALU. If all three results are greater than 0, it indicates that the pixel is inside the triangle; if one or more results are less than 0, it indicates the pixel is outside the triangle. If one result is 0, it indicates that the point is located on the edge of the triangle. If two results are 0, it indicates that the point is a vertex of the triangle where two edges intersect. The same applies to polygons as well.

Step S604: for each vertex of the primitive, the bounding box information of the primitive is determined according to an extreme value of position information of each vertex.

The coordinate system is defined as the x-axis to the right and they-axis downward, or can be defined as other coordinate systems.

Optionally, the GPU needs to calculate the bounding box according to the vertex coordinates through the PSU in the RSU.

The triangle is taken as an example for illustration. For a triangle, it is supposed that three vertices are V0, V1, and V2, and the corresponding screen coordinates thereof are (x0, y0), (x1, y1), and (x2, y2) respectively. The bounding box coordinate is represented as (xmin, ymin), (xmax, ymax). The x-axis to the right and y-axis downward are taken as an example for illustration, (xmin, ymin) represents an upper-left point of the bounding box of the primitive, and (xmax, ymax) represents a lower-right point of the bounding box of the primitive.

Then the calculation of the bounding box includes: the minimum X and minimum Y from the vertex coordinates are selected as the coordinate of the upper-left point of the bounding box; the maximum X and maximum Y are selected from the vertex coordinates as the coordinate of the lower-right point of the bounding box. Accordingly, the bounding box information is obtained, as shown in FIG. 7, the calculation result is as follows:

$$\begin{matrix}X min = min ( x 0 , x 1 , x 2 ) ; \\ Y min = min ( y 0 , y 1 , y 2 ) ; \\ X max = max ( x 0 , x 1 , x 2 ) ; \\ Y max = max ( y 0 , y 1 , y 2 ) .\end{matrix}$$

For the convenience of unified description, the bounding box is adjusted so that xmin, xmax, ymin, and ymax are all on valid sampling points, and the bounding box is a closed interval. that is, the possible drawn portion in the x-axis is [xmin, xmax], and in they-axis is [ymin, ymax].

In the embodiment, the edge function and bounding box information are calculated according to the vertex position information of the primitive. Subsequently, the type of the primitive can be determined according to the edge function and bounding box information, thereby determining whether the primitive needs to be removed in advance.

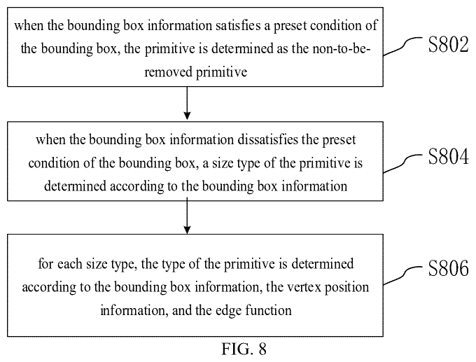

Continuing from the aforementioned embodiment, as shown in FIG. 8, the step of determining the type of the primitive according to the edge function and the bounding box information of the primitive may include following steps S802 to S806.

Step S802: when the bounding box information satisfies a preset condition of the bounding box, the primitive is determined as the non-to-be-removed primitive.

A bounding box size with the largest number in the performance analysis and prediction can be determined as the preset condition of the bounding box. For example, if the performance analysis and prediction find that there are many triangles with a bounding box occupying 2×2 pixels (i.e., the number of pixels in the x-direction x the number of pixels in the y-direction), in this case the preset condition of the bounding box can be that the bounding box occupies 2×2 pixels.

Optionally, continuing with the example of the triangular primitive, the GPU does not remove a triangle with a bounding box larger than 2×2 pixels, the size type is REJTYPE_NULL, and the primitive is the non-to-be-removed primitive.

When RejType==REJTYPE_NULL which indicates that no determination of small triangle removal is required, the output item Rej of Edge_ALU satisfies Rej=false, indicating that the triangle is not removed.

Step S804: when the bounding box information dissatisfies the preset condition of the bounding box, a size type of the primitive is determined according to the bounding box information.

Optionally, the GPU needs to perform small triangle removement for a triangle with a bounding box size less than or equal to 2×2 pixels, that is, when the bounding box information dissatisfies the preset condition of the bounding box, a triangle with a bounding box size less than or equal to 2×2 pixels needs to be removed. The size type of the primitive is determined according to the bounding box information. Two pixels in the x-direction and two pixels in the y-direction are taken as an example for illustration, the size type of the primitive may include the following four types:
REJTYPE_1×1: a width of the bounding box of the triangle is less than or equal to 1, and a height of the bounding box of the triangle is less than or equal to 1;
REJTYPE_2×1: a width of the bounding box of the triangle is less than or equal to 2, and a height of the bounding box of the triangle is less than or equal to 1;
REJTYPE_1×2: a width of the bounding box of the triangle is less than or equal to 1, and a height of the bounding box of the triangle is less than or equal to 2;
REJTYPE_2×2: a width of the bounding box of the triangle is less than or equal to 2, and a height of the bounding box of the triangle is less than or equal to 2.

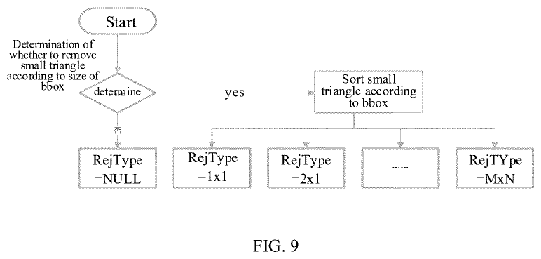

When RejType==REJTYPE_M×N (M represents the number of pixels in the x-direction, N represents the number of pixels in the y-direction), it indicates that the determination of the removement of the small triangle can be performed. The determination process is shown in FIG. 9.

Step S806: for each size type, the type of the primitive is determined according to the bounding box information, the vertex position information, and the edge function.

The type of the primitive may include the to-be-removed primitive and the non-to-be-removed primitive.

Optionally, for each size type, the GPU determines the type of the primitive through the RSU according to the bounding box information, the vertex position information, and the edge function.

Optionally, for the four size types REJTYPE_1×1, REJTYPE_2×1, REJTYPE_1×2, and REJTYPE_2×2, the GPU determines the type of the primitive with two pixels in the x-direction and two pixels in the y-direction as the to-be-removed primitive or non-to-be-removed primitive through the RSU according to the bounding box information, the vertex position information, and the edge function.

In the embodiment, it is further determined whether the primitive needs to be removed.

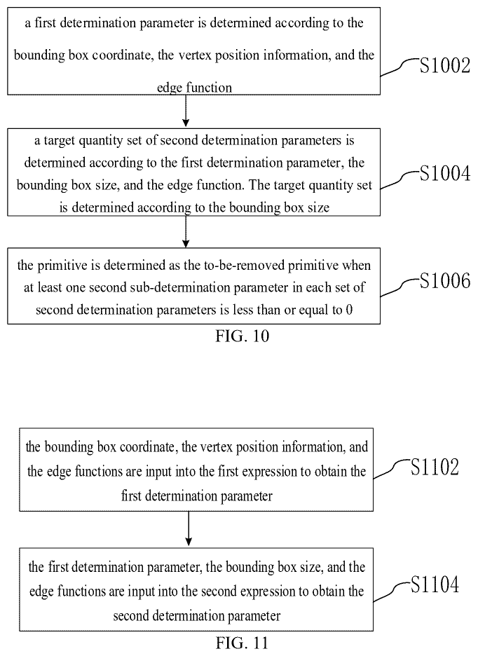

Following the above embodiments, as shown in FIG. 10, the bounding box information includes a bounding box size and a bounding box coordinate. The step of determining the type of the primitive according to the bounding box information, the vertex position information, and the edge function may include following steps S1002 to S1006.

Step S1002: a first determination parameter is determined according to the bounding box coordinate, the vertex position information, and the edge function.

The bounding box coordinate need to be transformed, such as the bounding box coordinate [xmin, xmax], [ymin, ymax] is transformed through (xmin+M−1)==xmax && (ymin+N−1)==ymax, to obtain the transformed bounding box coordinate [xmin, xmin+M−1], [ymin, ymin+N−1]. So that the bounding box coordinate contains only two coordinate elements, xmin and ymin.

The triangle is taken as an example for illustration. The three vertices of the triangle are V0, V1, and V2, and the corresponding screen coordinates are (x0, y0), (x1, y1), and (x2, y2) respectively. The coefficients A and B of the three edge functions corresponding to the triangle satisfy: edge_v0v1: A0, B0; edge_v1v2: A1, B1; edge_v2v0: A2, B2. The bounding box coordinate is represented as [xmin, xmin+M−1], [ymin, ymin+N−1].

Optionally, the GPU calculates the first determination parameter D through the RSU according to the bounding box coordinate, the vertex position information, and the edge function. The calculation formula for the first determination parameter D is as follows:

$$\begin{matrix}{D}_{0} = {A}_{0} * ( {x}_{min} - {x}_{1} ) + {B}_{0} * ( {y}_{min} - {y}_{1} ) \\ {D}_{1} = {A}_{1} * ( {x}_{min} - {x}_{2} ) + {B}_{1} * ( {y}_{min} - {y}_{2} ) \\ {D}_{2} = {A}_{2} * ( {x}_{min} - {x}_{0} ) + {B}_{2} * ( {y}_{min} - {y}_{0} )\end{matrix}$$

In the formula, D0, D1, D2 are first determination parameters, A0, B0, A1, B1, A2, B2 are the edge functions, xmin and ymin are the coordinate elements of the bounding box, and (x0, y0), (x₁, y1), (x2, y2) are the vertex coordinates.

Step S1004: a target quantity of sets of second determination parameters is determined according to the first determination parameter, the bounding box size, and the edge function. The target quantity of sets is determined according to the bounding box size.

Optionally, when the bounding box size is M*N, for example, M is equal to 2 and N is equal to 2 as an illustration, the GPU determines the target quantity of sets through the RSU according to the first determination parameter, the bounding box size, and the edge functions, that is, the 2*2 second determination parameters E, namely the second determination parameter corresponding to the size type 1×1, i.e., E corresponding to (x0, y0), the second determination parameter E corresponding to the size type 2×1, i.e., E corresponding to (x0+1, y0), the second determination parameter E corresponding to the size type 1×2, i.e., E corresponding to (x0, y0+1), and the second determination parameter E corresponding to the size type 2×2, i.e., E corresponding to (x0+1, y0+1).

The second determination parameter E includes the second sub-determination parameters E0 to E2, and the calculation formula is as follows:

$$\begin{matrix}{E}_{0} = {D}_{0} + m * {A}_{0} + n * {B}_{0} , m ∈ [ 0 , M - 1 ] , n ∈ [ 0 , N - 1 ] \\ {E}_{1} = {D}_{1} + m * {A}_{1} + n * {B}_{1} , m ∈ [ 0 , M - 1 ] , n ∈ [ 0 , N - 1 ] \\ {E}_{2} = {D}_{2} + m * {A}_{2} + n * {B}_{2} , m ∈ [ 0 , M - 1 ] , n ∈ [ 0 , N - 1 ]\end{matrix}$$

In the formula, D0, D1, D2 are first determination parameters, A0, B0, A1, B1, A2, B2 are edge functions, M and N represent the number of pixels occupied by the bounding box, and m and n represent pixel indices inside the bounding box (starting from 0). The size of the bounding box is based on the number of pixels occupied by the bounding box, which specifically can be represented as M*N.

Step S1006: the primitive is determined as the to-be-removed primitive when at least one second sub-determination parameter in each set of second determination parameters is less than or equal to 0.

The second determination parameter includes second sub-determination parameters.

Optionally, if there are one or more sets of m and n, such as in the size type 2*1, the corresponding second sub-determination parameters E0 to E2 are all greater than 0, this triangle (the primitive with 2 pixels in the x-direction and 2 pixels in the y-direction) needs to be drawn, that is, Rej=false. Otherwise, the primitive is the to-be-removed primitive.

In an optional embodiment, the triangular primitive with 2 pixels in the x-direction and 2 pixels in the y-direction is continuously taken as an example for illustration. Correspondingly, there are 4 second determination parameters E, that is, the second determination parameter E corresponding to (x0, y0), the second determination parameter E corresponding to (x0+1, y0), the second determination parameter E corresponding to (x0, y0+1), and the second determination parameter E corresponding to (x0+1, y0+1). In these four second determination parameters E, each second determination parameter E includes one or more second sub-determination parameters E0, E1, E2 less than or equal to 0, which indicates that the triangular primitive is the to-be-removed primitive, i.e., Rej=true.

In practical applications, the rasterizer stage requires a precision of 1/256, which needs to be represented by binary with 8 decimal places after the decimal point. It is supposed that a certain GPU can support a 4K*4K picture, then a range of an integer part of the screen coordinate is: 0≤X<2¹⁰, 0≤Y<2¹⁰, that is, the screen coordinates x and y, when represented in the binary, both need 19 fixed-point bits (fix sign bit. integer bit. decimal bit), denoted as fix1.10.8, where “1” is the sign bit, “10” is the integer bit, and “8” is the decimal bit. For formulas (1) and (2):

$$D = A * ( {x}_{min} - x ) + B * ( {y}_{min} - y ) \qquad ( 1 )$$

$$E = D + m * A + n * B \qquad ( 2 )$$

The bounding box of the triangle is limited to be within M×N pixels, so that |XMIN−Xi|≤M, |YMIN−Yi|≤N, |Ai|≤M, |Bi|≤N; then Ai*(BXMIN−Xi)≤M×M, Bi*(BYMIN−Yi)≤N×N. In that way for D and E, Ai*(BXMIN−Xi)+Bi*(BYMIN−Yi)≤M×M+N×N.

The removing of a small triangle with a bounding box less than or equal to 2×2 pixels is taken as an example. The bounding box of the triangle is within two pixels, so that |XMIN−Xi|<3, |YMIN−Yi|<3, that is, a bit width required for |XMIN−Xi| and |YMIN−Yi| is fix1.2.8. Similarly, since the triangle for determination is limited within two pixels, so that |Ai|<3, |Bi|<3, that is, the bit width of A and B is fix1.2.8. Ai*(BXMIN−Xi)<9, Bi*(BYMIN−Yi)<9, that is, the bit width is fix1.4.16. Accordingly, for the D, E, F, Ai*(BXMIN−Xi)+Bi*(BYMIN−Yi)<18, that is, the bit width is fix1.5.16. The bit width for each step of calculation is shown in the following Table 2.

TABLE 2
calculation of bit width for removing small triangle
with bounding box less than or equal to 2 × 2 pixels

| | | Fixed |
|---|---|---|
| | | Point |
| | | Width |
| | ALU Input Range | Needed |
| Edge functions Ai, Bi | \|Ai\| < 3, \|Bi\| < 3 | Fix1.2.8 |
| Coordinate of bounding box − | \|BXMIN − Xi\| < 3, | Fix1.2.8 |
| coordinate of vertex | \|BYMIN − Yi\| < 3 | |
| (BXMIN − Xi) or (BYMIN − Yi) | | |
| Edge function*(bounding box | Ai*(BXMIN − Xi) < 9, | Fix1.4.16 |
| coordinate − vertex coordinate) | Bi*(BYMIN − Yi) < 9 | |
| Ai*(BXMIN − Xi) or | | |
| Bi*(BYMIN − Yi) | | |
| Determination parameters Di, | Ai*(BXMIN − Xi) + | Fix1.5.16 |
| Ei, | Bi*(BYMIN − Yi) < 18 | |

In the embodiment, with the mode of determining whether the primitive is the to-be-removed primitive through the first determination parameter and the second determination parameter, the bit width of the GPU can be saved.

In an exemplary embodiment, as shown in FIG. 11, the calculation of the first determination parameter and the second determination parameter may include steps S1102 to S1104.

Step S1102: the bounding box coordinate, the vertex position information, and the edge functions are input into the first expression to obtain the first determination parameter.

Optionally, the GPU obtains the first determination parameter through the RSU by inputting the bounding box coordinate, the vertex position information, and the edge functions into the first expression as shown in the Formula (1) as follows:

$$D = A * ( {x}_{m i n} - x ) + B * ( {y}_{m i n} - y ) . \qquad ( 1 )$$

Step S1104: the first determination parameter, the bounding box size, and the edge functions are input into the second expression to obtain the second determination parameter.

Optionally, the GPU determines the second determination parameter through the RSU by inputting the first determination parameter, the bounding box size, and the edge functions into the second expression as shown in Formula (2) as follows:

$$E = D + m * A + n * B . \qquad ( 2 )$$

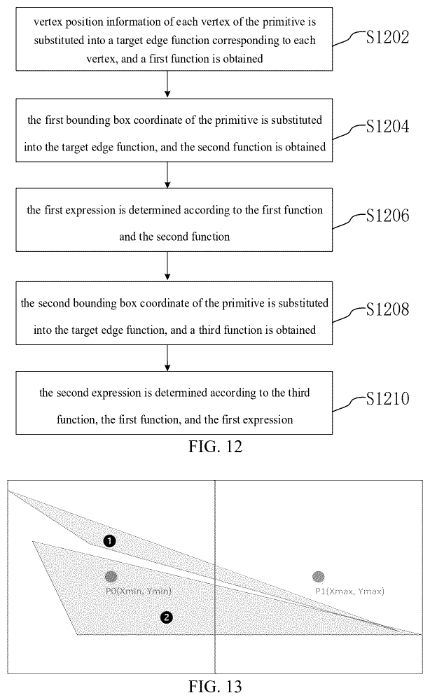

As shown in FIG. 12, the bounding box coordinate includes a first bounding box coordinate; the bounding box coordinate includes a second bounding box coordinate. The first bounding box coordinate and the second bounding box coordinate are determined based on the first coordinate element and the second coordinate element. The determination of the first expression and the second expression may include steps S1202 to S1210.

Step S1202: vertex position information of each vertex of the primitive is substituted into a target edge function corresponding to each vertex, and a first function is obtained.

The principle for removing a triangle with a bounding box less than or equal to 2×1 pixels is taken as an example. Three vertices of the triangle are V0, V1, V2, and corresponding screen coordinates thereof are (x0, y0), (x1, y1), (x2, y2). When the triangle covers two pixels (2×1), the bounding box coordinate is represented as [xmin, xmax], [ymin, ymax], where (xmin+1)==xmax && ymin==ymax. A point (xmin, ymin) is a pixel sampling point (also a center point) that may be covered, and is denoted as P0 (Pixel Center 0) for convenience of description. A point (xmax, ymax) is a pixel sampling point (also a center point) that may be covered, and is denoted as P1 (Pixel Center 1) for convenience of description. For the triangle of TYPE_2×1, it is required to determine whether the two pixel sampling points (xmin, ymin), (xmin+1, ymin) are outside or inside the triangle. If both the pixel sampling points are outside the triangle, the triangle does not need to be drawn and can be removed. As shown in FIG. 13, the triangle \textcircled{1} does not cover two pixel sampling points and does not need to be drawn, while the triangle \textcircled{2} covers one pixel sampling point and needs to be drawn. In the present disclosure, the first determination parameter and the second determination parameter are employed to determine whether the primitive covers a sampling point, instead of directly inputting the coordinate of the sampling point into the edge function to determine whether the primitive covers the sampling point, because it requires a large bit width to directly input the coordinate of the sampling point into the edge function, which may waste valuable hardware resources. The specific analysis is provided as follows.

The (xmin, ymin) is directly substituted into the edge function for calculation, an edge V0V1 is taken as an example, through Formula (3) to calculate as follows:

$$( {y}_{0} - {y}_{1} ) * x + ( {x}_{1} - {x}_{0} ) * y + ( {x}_{0} * {y}_{1} - {y}_{0} * {x}_{1} ) = 0 \qquad ( 3 )$$

When it is impossible to limit ranges of (x₀*y₁) and (y₀*x₁), only the (x₀*y₁) and (y₀*x₁) require the bit width of fix1.20.16 respectively. Compared to the calculation bit width in Table 2, the calculation amount is significantly larger and the cost is higher.

Accordingly, it is determined whether the primitive is the to-be-removed primitive through the first determination parameter and the second determination parameter, and then it is determined whether the primitive needs to be removed.

D0 to D2 are employed to determine whether P0 is inside or outside the triangle, and E0 to E2 are employed to determine whether P1 is inside or outside the triangle. If P0 or P1 or both P0 and P1 are inside the triangle, this triangle needs to be drawn and cannot be removed. If both P0 and P1 are outside the triangle, this triangle does not need to be drawn and can be removed.

Optionally, the vertex V1 (x1, y1) is taken as an example for illustration, the corresponding target edge function is A0*X+B0*Y+C0=0. The GPU substitutes, through the RSU, V1 (x1, y1) into A0*X+B0*Y+C0=0, and obtains the first function, as shown in the following formula (4):

$$A 0 * x 1 + B 0 * y 1 + C 0 = 0 \qquad ( 4 )$$

Step S1204: the first bounding box coordinate of the primitive is substituted into the target edge function, and the second function is obtained.

Optionally, the GPU determines, through the RSU, the first bounding box coordinate (xmin, ymin) as the first sampling point and substitute the first bounding box coordinate into A0*X+B0*Y+C0=0, to obtain a value denoted as D0, i.e., the second function, as shown in the following formula (5):

$$A 0 * x min + B 0 * y min + C 0 = D 0. \qquad ( 5 )$$

Step S1206: the first expression is determined according to the first function and the second function.

Optionally, the GPU subtracts, through the RSU, the first function from the second function to obtain the first expression, as shown in the following formula (6):

$${D}_{0} = {A}_{0} * ( {x}_{m i n} - {x}_{1} ) + {B}_{0} * ( {y}_{m i n} - {y}_{1} ) . \qquad ( 6 )$$

Step S1208: the second bounding box coordinate of the primitive is substituted into the target edge function, and a third function is obtained.

Optionally, the GPU determines, through the RSU, the second bounding box coordinate (xmin+1, ymin) as a second sampling point and substitute the second bounding box coordinate into A0*X+B0*Y+C0=0, to obtain a value denoted as E0, i.e., the third function, as shown in the following formula (7):

$$A 0 * x min + B 0 * y min + A 0 + C 0 = E 0 \qquad ( 7 )$$

Step S1210: the second expression is determined according to the third function, the first function, and the first expression.

Optionally, the GPU substitutes, through the RSU, an expression obtained by subtracting the first function from the third function into the first expression, to determine the second expression, as shown in the following formula (8):

$${E}_{0} = {D}_{0} + {A}_{0} . \qquad ( 8 )$$

In a similar way, D1, D2, E1 and E2 can be derived as follows:

$${D}_{1} = {A}_{1} * ( {x}_{m i n} - {x}_{2} ) + {B}_{1} * ( {y}_{m i n} - {y}_{2} ) ;$$

$${D}_{2} = {A}_{2} * ( {x}_{m i n} - {x}_{0} ) + {B}_{2} * ( {y}_{m i n} - {y}_{0} ) ;$$

$${E}_{1} = {D}_{1} + {A}_{1} ;$$

$${E}_{2} = {D}_{2} + {A}_{2} .$$

To determine whether P0 is inside or outside the triangle, that is, to determine positive and negative conditions of D0 to D2, the second function is no longer used, but the first expression is used, which can save the bit width of the computational logic unit in the RSU of the GPU. Similarly, to determine whether P1 is inside or outside the triangle, that is, to determine the positive and negative conditions of E0 to E2, the third function is no longer used, but the second expression is used, which can also save the bit width of the computational logic unit.

It should be noted that for the case where D or E is equal to 0, it means that the pixel sampling point is located on the edge of the triangle. In this case, it is required to determine whether the point on the edge belongs to the interior of the triangle according to specific rasterization rules.

In the embodiment, the first expression and the second expression are deduced; the bounding box coordinate, the vertex position information and the edge functions are input into the first expression to obtain the first determination parameter; the first determination parameter, the bounding box size and the edge functions are input into the second expression to obtain the second determination parameter; and whether the point on the edge belongs to the interior of the triangle is determined according to the second determination parameter, accordingly the bit width is saved.

In an exemplary embodiment, the GPU receives, through the RSU, triangles and vertex information of the triangles output by the GS. For one triangle, it is assumed that three vertices are V0, V1, V2, and the corresponding screen coordinates are (x0, y0), (x1, y1), (x2, y2). The PSU can specifically be the TSU. The GPU inputs, through the TSU in the RSU, the vertex coordinates of the vertices into the initial edge functions to obtain that:

$$the edge function of {V}_{0} {V}_{1} : A 0 * X + B 0 * Y + C 0 = 0 :$$

$$( {y}_{0} - {y}_{1} ) * x + ( {x}_{1} - {x}_{0} ) * y + ( {x}_{0} * {y}_{1} - {y}_{0} * {x}_{1} ) = 0 ;$$

$$the edge function of {V}_{1} {V}_{2} : A 1 * X + B 1 * Y + C 1 = 0 :$$

$$( {y}_{1} - {y}_{2} ) * x + ( {x}_{2} - {x}_{1} ) * y + ( {x}_{1} * {y}_{2} - {y}_{1} * {x}_{2} ) = 0 ;$$

$$the edge function of {V}_{2} {V}_{0} : A 2 * X + B 2 * Y + C 2 = 0 :$$

$$( {y}_{2} - {y}_{0} ) * x + ( {x}_{0} - {x}_{2} ) * y + ( {x}_{2} * {y}_{0} - {y}_{2} * {x}_{0} ) = 0.$$

For a triangle, it is assumed that three vertices are V0, V1, and V2, and the corresponding screen coordinates are (x0, y0), (x1, y1), and (x2, y2) respectively. The bounding box coordinate is represented as (xmin, ymin), (xmax, ymax). The coordinate system with the x-axis to the right and the y-axis downward is taken as an example for illustration, xmin and ymin refer to the upper-left point of the bounding box of the primitive, while xmax and ymax refer to the lower-right point of the bounding box of the primitive.

The calculation of the bounding box includes: the minimum X and the minimum Y are selected from the vertex coordinates as the coordinate of the upper-left point of the bounding box; the maximum X and the maximum Y are selected from the vertex coordinates as the coordinate of the lower-right point of the bounding box. Accordingly, the bounding box information is obtained, and the calculation results are as follows:

$$X min = min ( x 0 , x 1 , x 2 ) ;$$

$$Y min = min ( y 0 , y 1 , y 2 ) ;$$

$$X max = max ( x 0 , x 1 , x 2 ) ;$$

$$Y max = max ( y 0 , y 1 , y 2 ) .$$

If the performance analysis and the prediction indicate that there are many triangles with bounding boxes occupying 2×2 pixels (the number of pixels in the x-direction multiplied by the number of pixels in the y-direction), in this case the preset condition of the bounding box may include that the bounding box occupies 2×2 pixels. In this case, for triangles with bounding boxes occupying more than 2×2 pixels, the GPU determines that RejType==REJTYPE_NULL. When RejType==REJTYPE_NULL, it indicates that no determination of small triangle removal is required, and the output item of Edge_ALU is that Rej=false, which indicates that the triangle is not removed. When RejType==REJTYPE_M×N, it indicates that the determination of small triangle removal can be performed. If the output item of Edge_ALU is that Rej=false, it indicates that the triangle cannot be removed; if Rej=true, it indicates that the triangle can be removed.

The determination of whether the triangle can be removed according to the determination parameters is converted into the determination of the output signal Rej of the EDGE_ALU. When Rej=false, it indicates that the triangle cannot be removed; when Rej=true, it indicates that the triangle can be removed.

For a triangle with a bounding box having a width less than or equal to M and a height less than or equal to N (M represents the number of pixels occupied by the bounding box in the x-direction, N represents the number of pixels occupied by the bounding box in the y-direction), an optimization for small triangle removal is performed on such triangle. That is, the bounding box has the coordinate [xmin, xmax], [ymin, ymax], then (xmin+M−1)==xmax && (ymin+N−1)==ymax.

The three vertices of the triangle are V0, V1, V2, and the corresponding screen coordinates are (x0, y0), (x1, y1), (x2, y2). A and B in the three edge functions corresponding to the triangle are as follows:

$$edge\_v 0 v 1 : A 0 , B 0 ;$$

$$edge\_v 1 v 2 : A 1 , B 1 ;$$

$$edge\_v 2 v 0 : A 2 , B 2.$$

According to the above data, the RSU calculates the first determination parameters D0, D1, D2, and the calculation formulas are as follows:

$${D}_{0} = {A}_{0} * ( {x}_{m i n} - {x}_{1} ) + {B}_{0} * ( {y}_{m i n} - {y}_{1} ) ;$$

$${D}_{1} = {A}_{1} * ( {x}_{m i n} - {x}_{2} ) + {B}_{1} * ( {y}_{m i n} - {y}_{2} ) ;$$

$${D}_{2} = {A}_{2} * ( {x}_{m i n} - {x}_{0} ) + {B}_{2} * ( {y}_{m i n} - {y}_{0} ) .$$

Whether to perform the small triangle removal is determined according to the second determination parameters E0, E1, E2, the calculation formulas are as follows:

$${E}_{0} = {D}_{0} + m * {A}_{0} + n * {B}_{0} , m ∈ [ 0 , M - 1 ] , n ∈ [ 0 , N - 1 ] ;$$

$${E}_{1} = {D}_{1} + m * {A}_{1} + n * {B}_{1} , m ∈ [ 0 , M - 1 ] , n ∈ [ 0 , N - 1 ] ;$$

$${E}_{2} = {D}_{2} + m * {A}_{2} + n * {B}_{2} , m ∈ [ 0 , M - 1 ] , n ∈ [ 0 , N - 1 ] .$$

If there exists one or more sets of m and n such that the corresponding E0 to E2 are all greater than 0, this triangle needs to be drawn, that is, Rej=false. Conversely, that is, for each set of m and n, at least one of E0 to E2 is less than or equal to 0, then the triangle can be removed, that is, Rej=true.

If the type of the primitive is the non-to-be-removed primitive, a pixel attribute of the primitive is determined according to the vertex information of the primitive, and the pixel attribute is configured to be inputted to the pixel shader.

It should be appreciated that although the steps in the flow charts involved in the above-mentioned embodiments are displayed in sequence according to the arrows, these steps are not definitely executed in the order indicated by the arrows. Unless there is a clear indication in this document, the execution of these steps is not strictly limited by the order indicated by the arrows, and these steps can be executed in other orders. Moreover, at least some of the steps in the flow charts involved in the above-mentioned embodiments can include multiple steps or multiple stages, and these steps or stages are not definitely executed simultaneously, but may be executed at different moments, and these steps or stages are not definitely executed in sequence, but may be in turns or alternated with other steps or at least some of the steps or stages in other steps.

In an embodiment, a graphic process unit (GPU) is provided, which may include a memory, a geometry shader (GS), a rasterizer unit (RSU), and a pixel shader (PS). The memory stores a computer program. The GS is configured to process an image to output a primitive and corresponding vertex information. The RSU, when executing the computer program, implements the steps in the above-mentioned embodiments of the method. The PS is configured to acquire a pixel attribute and perform shading processing according to the pixel attribute.

In an embodiment, a graphic process unit (GPU) is provided, which may include a rasterizer unit (RSU) including a primitive setup unit (PSU). A computational logic unit of the PSU is provided with a first signal input port, a second signal input port, a third signal input port, and a signal output port. The first signal input port is configured to receive a first coordinate element signal. The second signal input port is configured to receive a second coordinate element signal. The third signal input port is configured to receive a size type signal of a primitive. The signal output port is configured to output a sign signal indicating whether to remove a primitive.

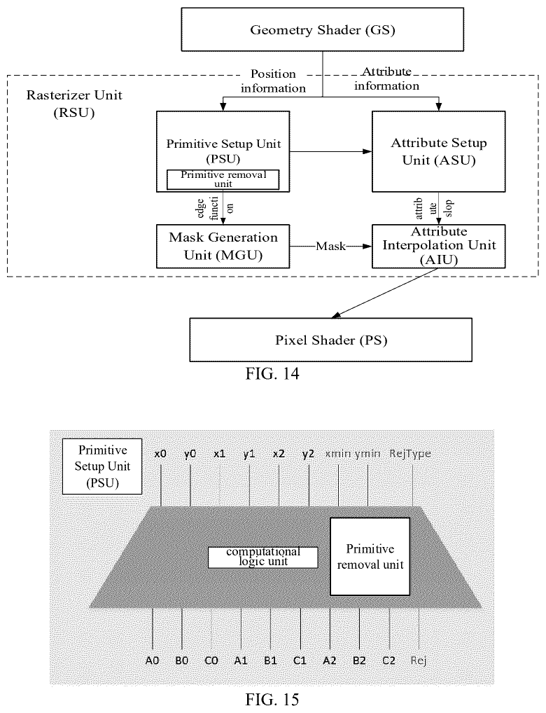

As shown in FIG. 14, the graphic process unit (GPU) includes the geometry shader (GS), the rasterizer unit (RSU), and the pixel shader (PS). The RSU includes the primitive setup unit (PSU), an attribute setup unit (ASU), a mask generation unit (MGU), and an attribute interpolation unit (AIU). The GS is connected to the PSU and the ASU, and the PSU is connected to the ASU. The PSU is connected to the MGU. The MGU and the ASU are connected to the AIU. The ARU is connected to the PS.

As shown in FIG. 15, the first signal input port, the second signal input port, the third signal input port and the signal output port are newly added to the computational logic unit of the PSU in the RSU. The first signal input port is configured to receive the first coordinate element signal, such as xmin. The second signal input port is configured to receive the second coordinate element signal, such as ymin. The third signal input port is configured to receive the size type signal of the primitive, such as rejtype. The signal output port is configured to output the sign signal indicating whether to remove the primitive, such as rej.

In an embodiment, a computer-readable storage medium is provided, on which a computer program is stored. The computer program, when executed by a rasterizer unit, may cause the rasterizer unit to implement the steps in the above-mentioned embodiments of the method.

In an embodiment, a computer program product is provided, which may include a computer program. The computer program, when executed by a rasterizer unit, may cause the rasterizer unit to implement the steps in the above-mentioned embodiments of the method.

A person of ordinary skill in the art can understand that all or part of the processes in the above-mentioned embodiments of the method can be implemented by instructing related hardware through a computer program. The computer program may be stored in a non-transitory computer-readable storage medium. When the computer program is executed, the processes of the above-mentioned embodiments of the method are included. Any reference to a memory, a database, or other medium used in the embodiments provided in the present disclosure may include at least one of a non-transitory memory and a transitory memory. The non-transitory memory may include a read-only memory (ROM), a magnetic tape, floppy disk, a flash memory, an optical storage, a high-density embedded non-transitory memory, a resistive random access memory (ReRAM), a magnetoresistive random access memory (MRAM), a ferroelectric random access memory (FRAM), a phase change memory (PCM), a graphene memory, etc. The transitory memory may include a random access memory (RAM) or an external cache memory, etc. By way of illustration and not limitation, the RAM may be in various forms, such as a static random access memory (SRAM) or a dynamic random access memory (DRAM). The database involved in each embodiment of the present disclosure may include at least one of a relational database and a non-relational database. The non-relational database may include, but is not limited to, a distributed database based on blockchain. The processor involved in each embodiment of the present disclosure may be a general-purpose processor, a central processing unit, a graphics processor, a digital signal processor, a programmable logic unit, a data processing logic unit based on quantum computing, artificial intelligence (AI) processor, etc., but is not limited thereto.

The technical features in the above embodiments may be combined arbitrarily. In order to make the description concise, all possible combinations of the technical features in the above embodiments are not described. However, as long as there is no contradiction in the combinations of these technical features, these combinations should be considered to be within the scope of the present application.

The above-described embodiments only express several implementation modes of the present disclosure, and the descriptions are relatively specific and detailed, but should not be constructed as limiting the scope of the present disclosure. It should be noted that, those of ordinary skill in the art can make several transformations and improvements without departing from the concept of the present disclosure, and these all fall within the protection scope of the present disclosure. Therefore, the protection scope of the present disclosure should be subject to the appended claims.

What is claimed is:

1. A primitive processing method for a rasterizer stage, comprising:
acquiring a primitive and vertex information of the primitive;
determining a type of the primitive according to the vertex information;
removing the primitive when the type of the primitive is a to-be-removed primitive; and
determining a pixel attribute of the primitive according to the vertex information of the primitive when the type of the primitive is a non-to-be-removed primitive, wherein the pixel attribute is configured to be inputted into a pixel shader.

2. The method according to claim 1, wherein the vertex information comprises vertex position information, determining the type of the primitive according to the vertex information comprises:
determining an edge function and bounding box information of the primitive according to the vertex position information; and
determining the type of the primitive according to the edge function and the bounding box information of the primitive.

3. The method according to claim 2, wherein determining the edge function and the bounding box information of the primitive according to the vertex position information comprises:
determining the edge function of the primitive according to vertex position information and an initial edge function for each vertex of the primitive;
determining the bounding box information of the primitive according to an extreme value of the vertex position information of each vertex of the primitive.

4. The method according to claim 2, wherein determining the type of the primitive according to the edge function and the bounding box information of the primitive comprises:
when the bounding box information satisfies a preset condition of the bounding box, determining the primitive as the non-to-be-removed primitive;
when the bounding box information dissatisfies the preset condition of the bounding box, determining a size type of the primitive according to the bounding box information; and
determining the type of the primitive according to the bounding box information, the vertex position information, and the edge function for the size type.

5. The method according to claim 4, wherein the bounding box information comprises a bounding box size and a bounding box coordinate, determining the type of the primitive according to the bounding box information, the vertex position information, and the edge function comprises:
determining a first determination parameter according to the bounding box coordinate, the vertex position information, and the edge function;
determining a target quantity of sets of second determination parameters according to the first determination parameter, the bounding box size, and the edge function, wherein the target quantity of sets is determined according to the bounding box size; and
determining the primitive as the to-be-removed primitive when at least one second sub-determination parameter in each set of second determination parameters is less than or equal to 0.

6. The method according to claim 5, wherein determining the first determination parameter according to the bounding box coordinate, the vertex position information, and the edge function comprises:
inputting the bounding box coordinate, the vertex position information, and the edge function into a first expression to obtain the first determination parameter;
wherein determining a second determination parameter according to the first determination parameter, the bounding box size, and the edge function comprises:
inputting the first determination parameter, the bounding box size, and the edge function into a second expression to obtain the second determination parameter;
wherein the bounding box coordinate comprises a first bounding box coordinate and a generation mode of the first expression comprises:
substituting the vertex position information of each vertex of the primitive into a target edge function corresponding to each vertex, and obtaining a first function;
substituting the first bounding box coordinate of the primitive into the target edge function, and obtaining a second function; and
determining the first expression according to the first function and the second function;
wherein the bounding box coordinate comprises a second bounding box coordinate, the first bounding box coordinate and the second bounding box coordinate are determined according to a first coordinate element and a second coordinate element, and a generation mode of the second expression comprises:
substituting the second bounding box coordinate of the primitive into the target edge function, and obtaining a third function;
determining the second expression according to the third function, the first function, and the first expression.

7. A graphic process unit (GPU), comprising a memory storing a computer program, a geometry shader (GS), a rasterizer unit (RSU), and a pixel shader (PS), wherein the GS is configured to process an image to output a primitive and corresponding vertex information, the PS is configured to acquire a pixel attribute and perform shading processing according to the pixel attribute, the RSU, when executing the computer program, is configured to:
acquire a primitive and vertex information of the primitive;
determine a type of the primitive according to the vertex information;
remove the primitive when the type of the primitive is a to-be-removed primitive; and
determine a pixel attribute of the primitive according to the vertex information of the primitive when the type of the primitive is a non-to-be-removed primitive, wherein the pixel attribute is configured to be inputted into a pixel shader.

8. The GPU according to claim 7, wherein the RSU comprises a primitive setup unit (PSU), a computational logic unit of the PSU is provided with a first signal input port, a second signal input port, a third signal input port, and a signal output port; the first signal input port is configured to receive a first coordinate element signal, the second signal input port is configured to receive a second coordinate element signal, the third signal input port is configured to receive a size type signal of the primitive, the signal output port is configured to output a sign signal indicating whether to remove the primitive.

9. The GPU according to claim 7, wherein the RSU, when executing the computer program, is further configured to:
determine an edge function and bounding box information of the primitive according to the vertex position information; and
determine the type of the primitive according to the edge function and the bounding box information of the primitive.

10. The GPU according to claim 7, wherein the RSU, when executing the computer program, is further configured to:
determine the edge function of the primitive according to vertex position information and an initial edge function for each vertex of the primitive;
determine the bounding box information of the primitive according to an extreme value of the vertex position information of each vertex of the primitive.

11. The GPU according to claim 7, wherein the RSU, when executing the computer program, is further configured to:
determine the primitive as the non-to-be-removed primitive when the bounding box information satisfies a preset condition of the bounding box;
determine a size type of the primitive according to the bounding box information when the bounding box information dissatisfies the preset condition of the bounding box; and
determine the type of the primitive according to the bounding box information, the vertex position information, and the edge function for the size type.

12. The GPU according to claim 7, wherein the RSU, when executing the computer program, is further configured to:
determine a first determination parameter according to the bounding box coordinate, the vertex position information, and the edge function;
determine a target quantity of sets of second determination parameters according to the first determination parameter, the bounding box size, and the edge function, wherein the target quantity of sets is determined according to the bounding box size; and
determine the primitive as the to-be-removed primitive when at least one second sub-determination parameter in each set of second determination parameters is less than or equal to 0.

13. The GPU according to claim 7, wherein the RSU, when executing the computer program, is further configured to:
input the bounding box coordinate, the vertex position information, and the edge function into a first expression to obtain the first determination parameter;
input the first determination parameter, the bounding box size, and the edge function into a second expression to obtain the second determination parameter;
wherein the bounding box coordinate comprises a first bounding box coordinate, and a generation mode of the first expression comprises:
substituting the vertex position information of each vertex of the primitive into a target edge function corresponding to each vertex, and obtaining a first function;
substituting the first bounding box coordinate of the primitive into the target edge function, and obtaining a second function; and
determining the first expression according to the first function and the second function;
wherein the bounding box coordinate comprises a second bounding box coordinate, the first bounding box coordinate and the second bounding box coordinate are determined according to a first coordinate element and a second coordinate element, and a generation mode of the second expression comprises:
substituting the second bounding box coordinate of the primitive into the target edge function, and obtaining a third function;
determining the second expression according to the third function, the first function, and the first expression.

14. A non-transitory computer-readable storage medium, on which a computer program is stored, wherein the computer program, when executed by a rasterizer unit, causes the rasterizer unit to implement the method of claim 1.

15. A computer program product, comprising a computer program, wherein the computer program, when executed by a rasterizer unit, causes the rasterizer unit to implement the method of claim 1.
